(19) United States
(12) Patent Application Publication
(10) Pub. No.: US 2021/0106408 A1
(43) Pub. Date: Apr. 15, 2021

(54) DENTAL ORTHOSIS, ASSOCIATED CHARACTERISATION AND/OR MANUFACTURING METHODS

(71) Applicant: ORTHOMOOV, Eguilles (FR)

(72) Inventors: Frédéric DOSDA, Gilly-sur-Isere (FR); Philippe PELLAT, Pertuis (FR); Arnaud MARCHADIER, Ceyreste (FR)

(73) Assignee: ORTHOMOOV, Eguilles (FR)

(21) Appl. No.: 17/046,435

(22) PCT Filed: Apr. 11, 2019
(86) PCT No.: PCT/FR2019/050858

§ 371 Date: Nov. 5, 2020

(30) Foreign Application Priority Data
Apr. 11, 2018 (FR) 1853153

(51) Int. Cl. A61C 7/14; A61C 7/18; A61C 9/00; A61C 7/20; B33Y 80/00; B33Y 50/00; B33Y 10/00; B29C 64/386; G06F 30/10

(52) U.S. Cl. CPC A61C 7/143; A61C 7/18; A61C 9/004; A61C 7/20; B29L 2031/7532; B33Y 50/00; B33Y 10/00; B29C 64/386; G06F 30/10; B33Y 80/00

(57) ABSTRACT

The invention relates to a dental orthosis, which includes a body having an inner surface and an outer surface, the body being arranged to homothetically cover a portion of a dental crown, an attachment having a gap and engaging with no degree of freedom with the outer surface of the body. The outer surface of the body advantageously includes a regular protrusion, the protrusion being arranged to constitute the attachment by material shrinkage, the body and protrusion being made as a single part.

The invention relates to the field of dental devices or orthoses. Such devices or orthoses are utilized for all types of uses and preferentially, but non-limitatively, in relation to the accurate transmission of mechanical forces required to control one or more tooth movements, in the context in particular of the use of a dental appliance, more particularly orthodontic orthotics and prosthetics.

Within the meaning of the invention and throughout the document, for the sake of simplicity, the terms “dental orthosis” or “orthodontic orthosis” and “dental device” or “orthodontic device” will be used interchangeably.

Although opinions have developed considerably during recent decades, it is currently still difficult for many people to accept orthodontic treatment, both for younger people and for adults. However, although wearing a dental appliance is not generally pleasant, and also very often dreaded, the usefulness of these orthodontic treatments is no longer questioned.

Orthodontics studies the shape, the position and the function of the teeth and/or dental arches and makes it possible, by its varied applications, to modify said teeth and/or dental arches in order in particular to ensure their health, enhance their appearance and improve their function. Thus, orthodontics consists of a technique for correcting poor postures of one or more jaws and/or teeth, in order in particular to optimize the postural balance between the bone structures, the occlusion, as well as the development of the bone bases for functional and aesthetic purposes. It aims more particularly to move the teeth, more particularly the dental crowns, in the three defined spatial directions in order to establish an attractive, functional and balanced occlusion. A dental crown is generally defined by five faces: an occlusal face, a lingual face, a vestibular face, a mesial face and a distal face. Controlling a tooth movement generally requires the appropriate combination of forces and/or moments applied over all or part of the respective crown or crowns of the teeth to be moved. Said movement or movements are generally carried out according to different data associated with orders, also called “curvatures”. In orthodontic terms, an order corresponds to an angle intended to describe one or more deformations capable of being performed on an orthodontic archwire or wire having a rectangular or cylindrical cross section. Three orders are thus defined:
a first order consisting of a deformation performed in the occlusal plane,
a second order consisting of a deformation performed in a vertical direction,
a third order consisting of a deformation by edgewise torque of the archwire.

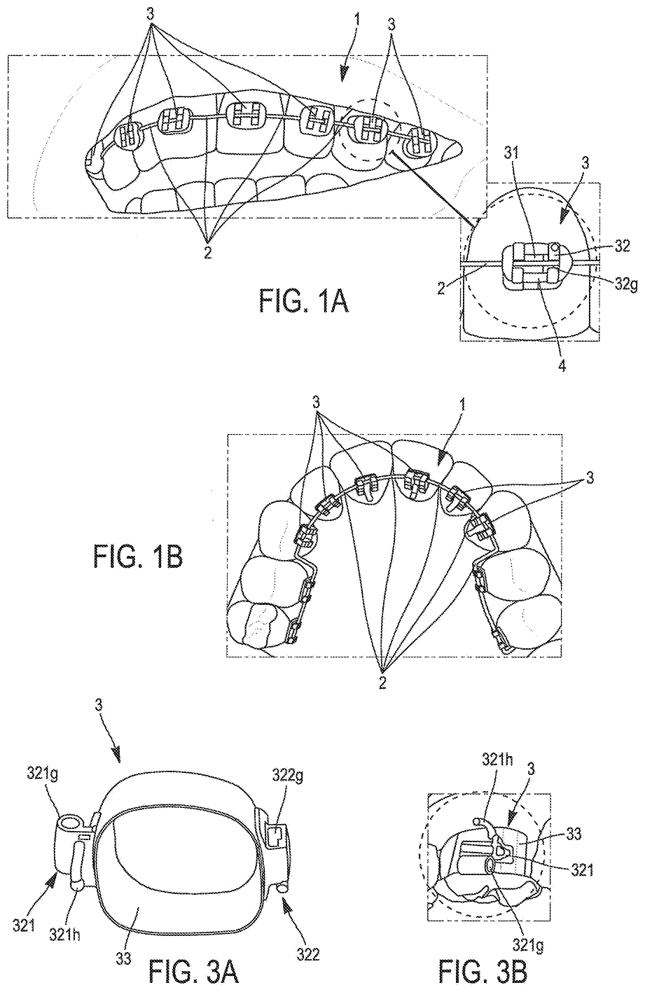

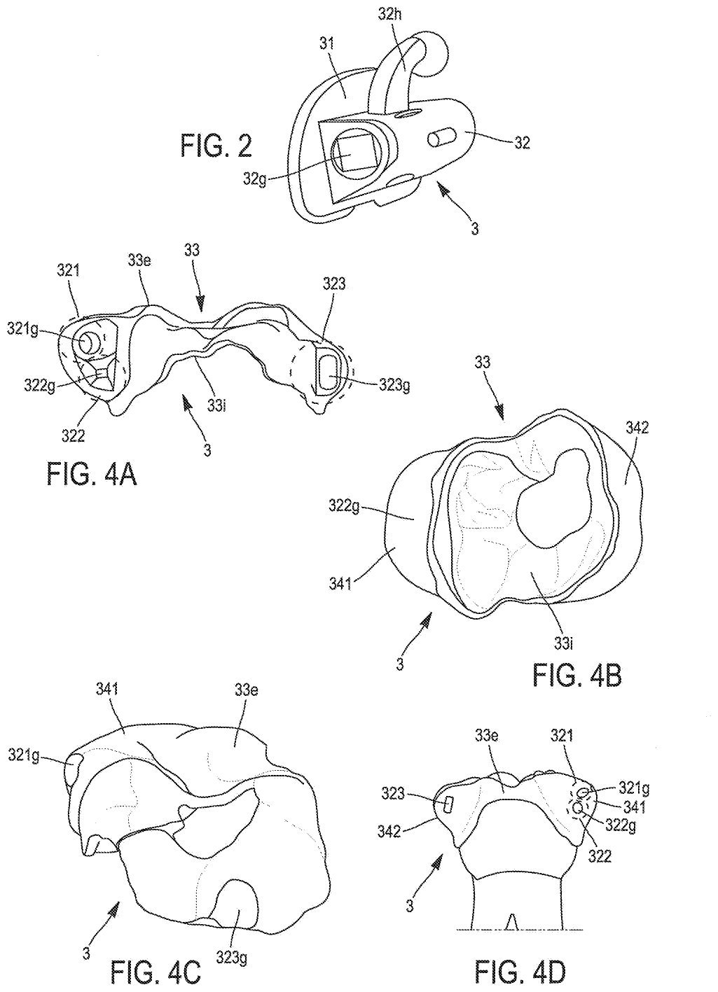

To allow such control and finally a movement of one or more teeth, current orthodontic techniques are based on the use of orthodontic appliances. FIGS. 1A and 1B show two known embodiments of orthodontic appliances placed in the mouth of a user or patient, respectively in the case of a vestibular technique and in the case of a lingual technique. Such an orthodontic appliance 1 generally comprises at least one metal wire 2, also called “orthodontic archwire” arranged to exert a force on the teeth, thus making it possible to guide and deliver the force needed to move a tooth with the aim of bringing the teeth to a satisfactory final position. Within the meaning of the invention and throughout the document, by “orthodontic archwire” is meant a treatment wire, but also any element making it possible to exert an extra-oral force (also known by the term “extra-buccal force” and respectively by the acronyms “EOF” or “EBF”). Said orthodontic appliance 1 also comprises several brackets 3, also known by the term “locks”, which for the sake of simplicity will be called “dental orthosis” in the remainder of the document, positioned on one of the faces of the respective crowns of the teeth, for example, according to a first embodiment described in relation to FIG. 1A, on their vestibular face or also, according to a second embodiment described in relation to FIG. 1B, on their lingual face. The position of the dental orthoses on a preferred face of the crowns depends mainly on the orthodontic treatment preferred by the practitioner and/or an aesthetic choice required by the user or the patient. Each dental orthosis 3 advantageously has or comprises a bracket 32 itself having a groove 32g, generally with a rectangular or square cross section (also known by the term “edgewise” appliance), arranged to accommodate an orthodontic archwire and thus allow said orthodontic archwire 2 to transfer forces to the tooth, in order to ensure adequate movement of said tooth during the treatment. As already mentioned, the transfer of forces to the tooth is advantageously determined as a function of data associated with the first, second and third orders previously described. In a variant, as will be described hereinafter in relation to FIG. 2, the bracket 32 can optionally have a tubular or cylindrical shape, with a circular or rectangular cross section. It is then called a tube bracket. Said orthodontic appliance 1 also comprises several ligatures 4 consisting of devices making it possible to hold the orthodontic archwire 2 in respective grooves 32g of the dental orthoses 3. Such ligatures 4 can be mainly constituted by steel, or, in a variant, according to the first embodiment described in relation to FIG. 1A, an elastomer.

During the placement of an orthodontic treatment, as described in particular in relation to FIG. 1A, several dental orthoses 3 are fixed individually to each of the dental crowns of a dental arch in a determined position. In order to ensure suitable positioning of the bracket on the dental crown, such fixing can be carried out, according to a first embodiment described in relation to FIG. 2, via a base 31, i.e. of an intermediate object or element a surface of which hugs the vestibular face of the dental crown by bonding and the other surface of which co-operates with the bracket 32, said bracket 32 having at least one groove 32g. It is then known as a dental orthosis in the form of a base/bracket assembly, which is also known. According to the first embodiment described in relation to FIG. 2, the bracket 32 also comprises a hook 32h, arranged to co-operate with an additional tensioning element, such as an elastic band.

In a variant, other dental orthoses. such as, according to the embodiment example described in relation to FIGS. 3A and 3B, an orthodontic band 3, can be used to allow the fixing of one or more brackets, in particular when the mechanical forces requires for tooth movement and more generally an orthodontic treatment are significant, when the dental crown is covered with amalgam or other metals after, for example, the placing of a metal crown, and when the enamel surface available on the dental crown is not sufficient to attach a regular bracket thereto, such as a base/bracket assembly previously described. In fact, orthodontic bands have various advantages. Such orthodontic bands better resist the exerted stresses originating from an occlusal trauma, inadequate mastication and/or application of an excessive external force on orthodontic archwires or the brackets. Said bands 3 also make it possible to place additional removable treatment elements, such as by way of non-limitative example, an extra-oral force, a transpalatal arch, a pendulum spring appliance on the maxillary arch or also a “lip bumper” on the maxillary and/or mandibular arches. Moreover, such bands 3 can be placed on a dental crown, where, when a glue is used, drying is difficult to achieve. Such orthodontic bands 3 are generally made from stainless steel or a precious metal alloy and can be fixed on a molar dental crown of a patient by means of, for example, a cement that is not very sensitive to moisture.

According to a second embodiment described in relation to FIGS. 3A and 3B, a dental orthosis 3 in the form of an orthodontic band comprises a preformed metal band or ring 33, i.e. a metal strip formed in the shape of a ring fitting tightly around the dental crown. Such a preformed band 33 is generally manufactured industrially, i.e. in large quantity, in multiple determined sizes and will be selected during orthodontic treatment depending on the anatomy of the patient, more particularly according to the anatomy of the dental crown. This results in a residual clearance between the band and the dental crown which is generally filled with a sealing cement. Still according to FIG. 3, such a preformed band 33 co-operating by welding, i.e. with zero degrees of freedom, with two tubular brackets 321, 322, i.e. two brackets respectively having two substantially tubular channels, said brackets 321, 322 being arranged to each accommodate an orthodontic archwire and positioned facing the vestibular face, also called outer face, and/or the lingual face, also called inner or palatal face, of the dental crown on which the band 33 is placed. Unlike a conventional bracket having a groove, a tubular bracket defines a channel. Within the meaning of the invention and throughout the document, by “channel” is meant any central through orifice, hole or cavity, arranged in the bracket in order to allow the passage or support of an orthodontic archwire 2. Such a tubular bracket thus has a cylindrical inner wall or a wall comprising flat cross sections substantially parallel to a longitudinal axis of the bracket channel, as is the case for a channel having a rectangular cross section for example. At the level of the outer face of the band 33 of a dental orthosis, such as that described in relation to FIGS. 3A and 3B, the tubular brackets 321, 322 can have two types of tubes: a tube having a channel 322g with a substantially rectangular cross section arranged to receive an orthodontic archwire and be positioned on at least one terminal molar fitted with a dental arch, and/or a tube having a channel 321g with a substantially circular cross section arranged to receive a treatment accessory. At the level of the band 33 of a dental orthosis, the tubular brackets 321, 322 can have a tube of any cross section, such a tube being arranged to connect an accessory or a treatment wire. In comparison with conventional brackets having grooves, such tubular brackets have various advantages, among which can be mentioned in particular: secure and appropriate placement of an orthodontic archwire on a dental crown that is difficult to reach since it is not very accessible, as well as the absence of the need to use a ligature to keep an orthodontic archwire within the tubular bracket, unlike a bracket comprising a groove.

Although responding to certain difficulties associated with the intrinsic anatomy of the dental arch of a patient, such tubular brackets have a number of drawbacks. More particularly, the absence of ligature, by the structure of said brackets, leads to the creation of clearance between the orthodontic archwire and the tubular bracket or brackets, leading to a loss of readout of the data relative to the first, second and third orders present in the band and finally altering the orthodontic treatment. Although a clearance between the orthodontic archwire and the tubular bracket or brackets is generally necessary at the beginning of an orthodontic treatment, in particular to allow the patient to adapt to said treatment, said clearance must be as little as possible to ensure a tooth movement consistent with the prescribed orthodontic treatment. Several factors are the cause of this clearance, such as for example the dimensions, more particularly the size of the orthodontic archwire and the dimensions of the channel or the hole. In fact, for practical reasons, industrial manufacturers generally design orthodontic archwires, the dimensions of which are not generally consistent with an optimal dimension for inserting said archwire into the bracket. Similarly, industrial manufacturers generally design grooves or tubes the tolerances of which in terms of dimensions and data relative to the first, second and third orders are not necessarily consistent with the real values. The grooves or tubes are thus often oversized to allow and facilitate insertion of the orthodontic archwire into the groove or the tube by the practitioner. Moreover, the groove or the tube, which must be U-shaped, i.e. having a flat base, also has variations in dimensions between its apex and its base.

As already mentioned, although such clearance is necessary, the latter must not go above a critical angle Θ_{C}. Above this, the clearance reduces, or even cancels out, the orthodontic treatment. In fact, the more the angle created by the clearance increases, the more the deformation of the orthodontic archwire increases. Furthermore, the more the force required for the movement increases, the more the width of the orthodontic archwire increases, and finally the more the size of the orthodontic archwire increases and the more the critical angle decreases. It is thus necessary to use a tubular bracket that is sufficiently long, at least three millimetres, and accurately designed to obtain optimal control of the tooth movement.

Moreover, the positioning of the tubular bracket with regard to the dental crown plays a crucial role. In fact, the distance separating the base of the tube from the tooth determines the horizontal position of a tooth with respect to another. Obtaining an alignment of all the points of contact of the teeth of a dental arch of a patient is a functional necessity. It is thus necessary for the distance separating the base of the groove on the vestibular face of a tooth to be adapted to this anatomy. This constraint is generally difficult to fulfil with dental orthoses in the form of conventional preformed bands, such as the band 33 described more particularly in relation to FIG. 3A, in particular due to the difficulties imposed by the try-in and/or placement of such preformed bands.

Furthermore, a dental orthosis in the form of a preformed band also has a certain number of drawbacks. In fact, such a dental orthosis in the form of a preformed band, by its design in particular, does not provide a positioning that is perfectly adapted to the morphology of the dental crown of the patient or the user on whom the orthosis is placed. As a result, an unsuitable positioning of said preformed band directly impacts the quality and/or the efficacy of the orthodontic treatment. Furthermore, choosing a suitable size of preformed band requires a certain level of experience and/or a certain dexterity on the part of a practitioner; the efficacy of the treatment may be reduced by an unsuitable choice by said practitioner. The placement of one or more preformed bands respectively on one or more dental crowns, more particularly passing the contact point of a band around a dental crown, is often painful for a patient, as the interdental space, if not practically nonexistent, is generally less than the thickness of the preformed band. To ensure an optimal placement of one or more preformed bands, a patient and a practitioner must generally arrange a prior appointment for placing separators, making it possible to create and/or increase a space between the dental crowns, increasing the discomfort of the patient. Furthermore, by its arrangement and the use of additional components to ensure an optimal positioning, in the case where a preformed band has to be removed and replaced, the reproducibility of the replacement of the band is generally difficult to obtain.

As a result, the fit of a preformed band on a dental crown of a patient is generally not optimal, such a band conventionally being oversized with respect to the dental crown. To make up for such oversizing, the practitioner uses an adhesive layer, generally thicker, which then supplies the lack. However, using such an adhesive layer then leads to a lower quality hold, with a potential risk of leakage and finally a risk of carious attacks. In addition, during an orthodontic treatment, it can be necessary for either the practitioner or the patient to insert and/or remove accessories, such as an orthodontic archwire, within the bracket or brackets of the preformed band. Such insertions and/or removals thus lead to micromovements, ultimately capable of leading to a detachment of the dental orthosis.

Furthermore, as the preformed bands are designed on an industrial scale, the choice of brackets, more particularly data relative to the first, second and third orders necessary for orthodontic treatment is generally determined by the supply proposed by manufacturers, very often limited, which, depending on the case, are not always applicable to the orthodontic treatment or are not always optimal for certain patients. Also, by design and production on an industrial scale, the position of the tubular bracket is not always suitable for the needs of a customized orthodontic treatment. It thus requires the practitioner to modify the orthodontic archwire to overcome this inaccuracy, leading to further additional difficulties. Moreover, by its design and its particular arrangement, such a preformed band, intended to be placed in the mouth of a patient for a certain time, is generally uncomfortable for the patient, or even damages the oral tissues. In fact, said preformed band generally has relatively pointed shapes and/or asperities due to the presence of brackets cooperating with the ring.

Due to various drawbacks present in relation to the preformed orthodontic bands 33, scientists have attempted to develop dental orthoses in the form of personalized bands, i.e. homothetically adapted to the patient or user, more particularly to the dental crown on which such a personalized band can be placed, said rings being manufactured by lost wax moulding. Such customized bands are generally custom-made and perfectly adapted to the morphology of the dental crown.

However, such dental orthoses, in the form of customized bands manufactured by lost wax moulding, have, like preformed bands, a certain number of drawbacks. In fact, the lost wax moulding manufacturing methods do not generally make it possible to achieve such optimal results and purposes in comparison with those obtained with printing or metal machining technologies. Moreover, the attachment of overmoulded metal brackets to the wax model makes it possible to obtain dental orthoses consisting of bands with tubular brackets, like the preformed bands. However, the attachment of one or more brackets significantly increases the final volume of the dental orthosis. As a result, the injection of a metal to manufacture said dental orthosis, by its limitations, in many cases requires a final re-machining of the bracket or brackets having one or more grooves and/or tubes. Such a re-machining thus considerably increases the costs and manufacturing time of such dental orthoses. Also, the technological constraints associated with the use of the lost wax moulding manufacturing method make it necessary to use softer metal alloys, optionally precious metal alloys. The use of such metal alloys may eventually present difficulties during manufacture of the dental orthosis at the end of the process.

In a variant, in order to overcome the various drawbacks presented in relation to the orthodontic bands that are preformed and/or customized by lost wax moulding, other researchers have attempted to develop dental orthoses in the form of personalized bands, i.e. homothetically adapted to the patient or user, more particularly to the dental crown on which such a personalized band can be placed, said rings being manufactured by machining, injection or also additive manufacturing. Such personalized bands are generally custom-made and perfectly adapted to the morphology of the dental crown of a patient. They are manufactured by three-dimensional (3D) printing or machining of materials or metal alloys intended for orthodontics. The manufacturing techniques thus make it possible to produce dental orthoses having very small thicknesses, thus allowing an increased comfort for the patient. In addition to the personalized band, such dental orthoses can comprise one or more orthodontic brackets having grooves, advantageously integrated with and/or welded to said personalized bands.

However, such dental orthoses, in the form of personalized bands having, like preformed bands, a certain number of drawbacks, as well as dental orthoses in the form of customized or preformed bands. In fact, the current processes for manufacturing such personalized bands do not make it possible to manufacture a dental orthosis comprising a personalized band co-operating with one or more tubular brackets in a single piece or a single operation. Once the band is printed, it is generally necessary to weld an industrially manufactured tubular bracket on said printed band. In fact, the current technologies for manufacturing dental orthoses require having construction supports inside the tubes and these cannot be removed after manufacturing without altering or deforming the shape and/or the state of the surface of the tubular bracket intended to be in contact with the orthodontic archwire. Like the preformed bands, such personalized bands have asperities which make the bands uncomfortable for the patients who wear them, or even, in certain cases, harmful.

The invention makes it possible to respond to all or part of the drawbacks raised by the known solutions.

Among the numerous advantages provided by the invention, it can be mentioned that it:
proposes a device in the form of a personalized dental orthosis, digitally designed and adapted to the anatomy of a patient, improving the hygiene and the comfort of said patient, reducing the risks of possible accidental detachment;
offers a dental orthosis assuring an optimal placement of the brackets of said orthosis according to a determined orientation of said brackets and adapted to the desired orthodontic treatment;
reduces the number of appointments at the dental surgery, while reducing the placement time of such a dental orthosis, and thus the inherent costs of orthodontic treatment.

To this end, a dental orthosis is in particular provided comprising a body having an inner surface and an outer surface, said body being arranged to homothetically cover a part of a dental crown, a bracket having a channel and co-operating with zero degrees of freedom with the outer surface of said body. To offer a patient a personalized orthodontic treatment the comfort and hygiene of which are greatly improved and to allow an accurate transmission of necessary mechanical forces during said orthodontic treatment, the inner surface of said body is arranged to homothetically cover at least a part of the three faces of said dental crown, one of which consisting of the vestibular face and the two others being selected from the lingual face, the occlusal face, the distal face and the mesial face, said bracket being arranged to be positioned on the vestibular face of the dental crown. Furthermore, the outer surface of said body comprises a regular protuberance, said protuberance being arranged to constitute said bracket by material removal. Finally, said body and said protuberance are made in a single piece.

Advantageously, the protuberance of a dental orthosis according to the invention can be convex.

Preferentially, but non-limitatively, to facilitate the anchoring of a dental orthosis according to the invention and improve the comfort of a patient wearing it, the inner surface of the body of said dental orthosis according to the invention can be arranged to homothetically cover a part of the occlusal face and a part of the lingual face and a part of the vestibular face of said dental crown.

Advantageously, but non-limitatively, the bracket channel of a dental orthosis according to the invention can advantageously be tubular with a circular or rectangular cross section.

As a variant or in addition, to reduce or avoid discomfort, or even any injury, of a patient wearing a dental orthosis according to the invention, the outer surface of the body thereof can be smooth, so that it does not have any asperity.

According to preferred, but non-limitative, embodiment examples of a dental orthosis according to the invention, the latter can consist of an orthodontic cap or a molar band.

In an advantageous but non-limitative embodiment, in response to a specific orthodontic treatment, more particularly to allow the use of several accessories, a dental orthosis according to the invention can comprise a second protuberance arranged to constitute a second bracket by material removal, said second bracket being arranged to be respectively positioned on the lingual face of the dental crown.

As a variant or in addition, the protuberance can be arranged to constitute a plurality of different brackets by material removal.

To comply with the constraints and standards imposed in orthodontics, but also to reduce, or even avoid, any allergy and/or sensitization, a dental orthosis according to the invention can be mainly constituted by a biocompatible material.

According to a second subject, the invention relates to a method for the characterization of a dental orthosis, said orthosis being according to the first subject of the invention.

In order to ensure the design of a dental orthosis according to the invention in a personalized and perfectly controlled manner, a method for the characterization of such an orthosis comprises:
a step for defining the body of the dental orthosis based on a first three-dimensional digital representation of a dental crown and producing a second three-dimensional digital representation of the body of the dental orthosis;
a step for selecting and associating the bracket channel with the second three-dimensional digital representation of the body of the orthosis, with respect to the outer surface of the body;
such a step for creating the protuberance by non-linear projection of the inner surface of the body, so that said protuberance constitutes the bracket.

In order to allow a rapid processing of the data and reduce the manufacturing time of a dental orthosis, a characterization method according to the invention can comprise a prior step of acquisition of the first digital representation of a dental crown in three dimensions.

Preferentially but non limitatively, during the manufacturing of a dental orthosis according to the invention is implemented by three-dimensional printing technologies, a characterization method according to the invention can comprise a step of producing a script that can be interpreted or executed by the processing unit of a device for developing volumes by addition of material, the interpretation or execution of which causes the production of the dental orthosis.

According to a third subject, regardless of the embodiment variant of a characterization method according to the invention, and in order to adapt a smart electronic object so that it can implement such a method, the invention relates to a computer program product comprising one or more instructions that can be interpreted or executed by the processing unit of an electronic object. The electronic object also comprises storage means or co-operates with such storage means, said program being loadable in said storage means. Said instructions by the processing unit are such that their interpretation or execution by said processing unit causes the implementation of a characterization method according to the second subject of the invention.

According to a fourth subject, the invention relates to a process for the manufacture of a dental orthosis, said orthosis being according to the first subject of the invention.

According to a first non-limitative embodiment of a manufacturing process according to the invention, the latter comprises:
the steps of a method for the characterization of a dental orthosis according to the second subject of the invention.
a step of subtractive manufacturing of said dental orthosis to carry out the material removal and constitute the bracket, consisting of a step of drilling, machining or moulding.

In a variant, in order to improve the accuracy of the manufacturing of a dental orthosis according to the invention, according to a second non-limitative embodiment of a manufacturing process according to the invention, the latter comprises:
the steps of a method for the characterization of a dental orthosis according to the second subject of the invention;
a step of additive manufacturing of said dental orthosis, consisting of a step of three-dimensional printing.

Finally, according to a fifth subject, the invention relates to an orthodontic appliance comprising two dental orthoses and an orthodontic archwire, said orthodontic archwire co-operating with said two dental orthoses. Preferentially but non-limitatively, at least one of the two dental orthoses is according to the first subject of the invention.

Other characteristics and advantages will become more clearly apparent on reading the following description and on examination of the attached figures, in which:

FIGS. 1A and 1B, described above, show two embodiments of known orthodontic appliances placed in the mouth of a user or patient, respectively in the case of a vestibular technique and in the case of a lingual technique;

FIG. 2, described above, illustrates a diagrammatic view of a first example of a known dental orthosis in the form of a base/bracket assembly;

FIGS. 3A and 3B, described above, show diagrammatic views of a second example of a known dental orthosis in the form of a molar band;

FIGS. 4A, 4B, 4C and 4D show respective diagrammatic views of a preferred but non-limitative embodiment of a dental orthosis according to the invention;

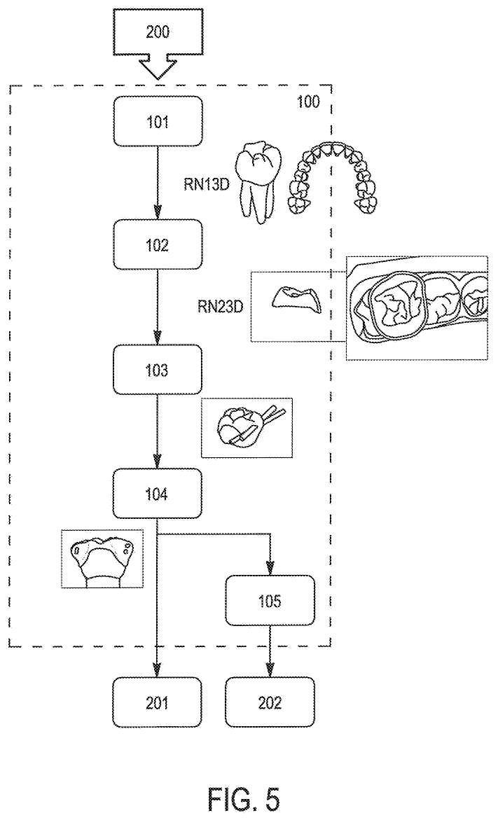

FIG. 5 shows a simplified flowchart of a process for the manufacture of a dental orthosis according to the invention.

FIGS. 4A to 4D respectively show respective diagrammatic views of a preferred but non-limitative embodiment of a dental orthosis according to the invention in the form of an orthodontic cap. In a variant, said dental orthosis can consist of a molar band. However, the invention will not be limited to these embodiment examples alone. In an etymological sense, an orthosis is an appliance intended to correct misalignment. An orthosis generally compensates for an absent or deficient function, assists a joint or muscular structure, stabilizes a part of the body during a period of rehabilitation or rest.

Within the meaning of the invention and throughout the document, by “dental orthosis” is meant any device, object or appliance intended to correct the posture of a tooth, more particularly its dental crown in order to, in particular, optimize the postural balance between the bone structures, the occlusion, as well as the development of the bone bases for functional and aesthetic purposes. Such a dental orthosis is thus arranged to transmit a mechanical force to a dental crown and thus move said dental crown within the three defined directions in space.

Such a dental orthosis is advantageously intended to be used by a subject or patient undergoing an orthodontic treatment, whether the latter be vestibular or lingual, with the aim of improving the appearance or the functions of the dental arch of said patient, such a patient being preferably but non-limitatively a human being. Said dental orthosis is advantageously personalized and adapted to the patient who wears it, meaning that it is for single use and temporary, since it will be in place for the time of the orthodontic treatment. Such a dental orthosis overcomes the known adjustment problems in relation to known industrial bands and as a consequence improves the comfort of the patient. To this end, the structure and arrangement of said dental orthosis will be personalized and adapted depending on said orthodontic treatment, more particularly its type and duration and on the dental crown on which it will be placed.

A dental orthosis 3 according to the invention comprises a body 33, said body being arranged to homothetically cover a part of a dental crown. Said crown is generally defined by five faces, in this case the lingual face, the occlusal face, the distal face, the mesial face and the vestibular face. Thus, by its particular arrangement, the body 33 has shapes and dimensions proportional to all or part, more particularly of the faces, of the dental crown and advantageously hugs all or part of the different faces of the dental crown.

To this end, the body 33 of a dental orthosis according to the invention has an inner surface 33i (also called “basal surface”), advantageously arranged to be in contact and homothetically resting on a part of the dental crown. Advantageously, in order to ensure better anchoring of a dental orthosis 3 according to the invention and to avoid the excessive use of glue or cement currently used for permanently holding said orthosis and the insertion of accessories or orthodontic archwires, the inner surface 33i of said body 33 is arranged to homothetically cover at least a part of three faces of said dental crown from the lingual face, the occlusal face, the distal face, the mesial face and the vestibular face. In fact, such a homothetic arrangement of the inner surface 33i of the body 33 is particularly advantageous in terms of hygiene in particular, since it minimizes the risks of leakage of glue or cement currently used with the current bands for placing and holding said bands, the quantities of glue or cement used being much smaller. Moreover, such an arrangement of the body 33 of an orthosis according to the invention improves the comfort of the patient, since the traumas caused by the insertion of preformed industrial bands in the subgingival area are reduced, or even eliminated. Also, due to a homothetical anatomical shape, the removal and maintenance of said orthosis are greatly facilitated. Preferentially, the inner surface 33i of the body 33 of a dental orthosis according to the invention is arranged to homothetically cover at least a part of three faces of said dental crown, one of which consisting of the vestibular face and the two others being selected from the lingual face, the occlusal face, the distal face and the mesial face, said bracket then being arranged to be positioned on the vestibular face.

Preferentially, but non-limitatively, according to an embodiment of a dental orthosis 3 described in relation to FIG. 4D, in order in particular to further optimise the positioning of a dental orthosis and to reduce, or even eliminate any discomfort and any hygiene risk for the patient wearing said orthosis, the inner surface 33i of said body 33 can be arranged to homothetically cover a part of the occlusal face and a part of the lingual face and a part of the vestibular face of said dental crown. In fact, access to the mesial and distal faces of a dental crown is generally limited by the space between two dental crowns, which can in certain cases be almost non-existent. Furthermore, the anchoring and placement of the dental orthosis according to the invention are greatly facilitated when the inner surface 33i of said body 33 is arranged to homothetically cover a part of the occlusal face.

Also, the body 33 of a dental orthosis 3 according to the invention has an outer surface 33e. Said outer surface 33e is advantageously arranged so as not to obstruct the positioning of the opposing teeth with respect to the dental crown equipped with the dental orthosis. The thickness of the body 33 between the inner surface 33i and the outer surface 33e is advantageously determined in response to such a criterion. Advantageously but non-limitatively, such a thickness can be greater than or equal to 0.5 millimetre. By way of non-limitative example, according to the embodiment of a dental orthosis 3 according to the invention described in particular in relation to FIGS. 4A to 4D, the outer surface 33e of the body 33 can be a resultant of the projection of the inner surface 33i, the body then substantially forming a casing, which could be called a sheath, a coping or a cap. Such an arrangement of the outer surface 33e facing the inner surface 33i of the body 33 is particularly advantageous, since it facilitates the design of the dental orthosis digitally. Preferentially but non-limitatively, the outer surface 33e of the body 33 can be substantially smooth, so that it does not have any asperity and/or roughness. Within known conventional dental orthoses, such asperities generally create surface unevenness or irregularities, thus making the outer surface 33e rough and thus increasing the discomfort of the patient. Moreover, an outer surface 33e that is substantially smooth makes it possible to improve oral hygiene, as the asperities may retain certain impurities or bacteria.

Like the known dental orthoses previously described, a dental orthosis 3 according to the invention comprises a bracket 321, 322, 323 having a channel, respectively 321g, 322g, 323g. As described above, such a bracket, more particularly its channel, is arranged to accommodate an orthodontic archwire 2 and thus allow said orthodontic archwire 2 to transfer forces to the dental crown, in order to ensure adequate movement of said dental crown during the orthodontic treatment.

As detailed above, it is necessary for such a bracket to co-operate durably and accurately, in particular from the perspective of its orientation, with zero degrees of freedom with the outer surface of the body of the dental orthosis, in order to preserve the different data associated with the orders. To offer a personalized dental orthosis, designed digitally and adapted to the anatomy of a patient, improving the hygiene and comfort of said patient, reducing the risks of an accidental disconnection of the orthosis and of the recipient dental crown and ensuring an optimal placement of the brackets of said dental orthosis by a determined and precise orientation of said brackets and adapted to the desired orthodontic treatment, according in particular to an embodiment of a dental orthosis according to the invention described in relation to FIGS. 4A to 4D, the invention provides for the outer surface 33e of said body 33 to comprise a regular protuberance 341, 342 i.e. that does not have any marked discontinuity or shoulder. Within the meaning of the invention and throughout the document, by “protuberance” is meant a prominent and projecting shape. Preferentially, but non-limitatively, a protuberance 341, 342 can be substantially convex, i.e. it has a spherical curvature in relief. To ensure the comfort of the patient without hindering their hygiene, like the outer surface 33e of the body, such a protuberance 341, 342 can be substantially smooth, so that it does not have any asperity or roughness. According to the invention, such a protuberance 341, 342 of a dental orthosis 3 according to the invention is arranged to constitute said bracket 321,322,323 by material removal. Said protuberance is thus advantageously arranged to comprise and accommodate the bracket 321,322,323 and thus define the channel 321g, 322g, 323g of said bracket 321,322,323. Different processes for manufacturing a dental orthosis according to the invention will be detailed below, thus demonstrating the constitution of such a bracket by material removal, such a material removal being able to be carried out virtually, i.e. digitally, by means of a method for the characterization of a dental orthosis according to the invention which will also be described below, or in actuality i.e. during the process for the manufacture of an orthosis according to the invention. To this end, the protuberance, by its dimensions and its shape, has sufficient material or thickness to constitute in the mass of the bracket 321, 322, 323 such an attachment having a channel respectively 321g,322g,323g, said channel thus being made within the protuberance during the process for the manufacture of said dental orthosis or virtually encapsulated by said protuberance or during the step of characterization of said dental orthosis. As a result, the shape and the dimensions of said protuberance 341,342 are adapted or arranged to create the protuberance and to bear one or more mechanical forces transmitted by an orthodontic archwire and/or any other accessory, thus making it possible to move a dental crown in the context of an orthodontic treatment. Like the outer surface 33e, the protuberance 341,342, more particularly its shape and its dimensions, are also and advantageously arranged so as not to disturb the positioning of the opposing teeth with respect to the dental crown equipped with the dental orthosis. Furthermore, depending on the orthodontic treatment, whether that be lingual or vestibular, the protuberance 341,342, and consequently the bracket 321,322,323 of a dental orthosis 3 according to the invention are arranged to be positioned preferentially on the vestibular face, optionally on the lingual face of the dental crown.

The protuberance 341,342 of a dental orthosis 3 according to the invention thus constitutes a bracket 321, 322, 323 having a channel respectively 321g, 322g, 323g, arranged to accommodate an orthodontic archwire 2 and thus allow said orthodontic archwire 2 to transfer forces to the dental crown, in order to ensure adequate movement of said dental crown during the orthodontic treatment. The channel 321g, 322g, 323g present within the protuberance 341,342 consists of a central through orifice, hole or cavity arranged in the bracket in order to allow the passage, or the support, of an orthodontic archwire 2 or any other orthodontic accessory. Said channel 321g, 322g, 323g is advantageously made, during a process for the manufacture of a dental orthosis according to the invention, by a virtual or real removal of material within the protuberance 341,342. Said protuberance 341,342 can thus have a cylindrical inner wall or a wall comprising flat cross sections substantially parallel to a longitudinal axis of the channel of a bracket, as is the case for a channel or an inner wall having a rectangular cross section for example. By way of non-limitative examples, according to a non-limitative embodiment of a dental orthosis 3 according to the invention described in relation to FIGS. 4A to 4D, the channel 321g, and consequently the inner wall, of the bracket 321 can advantageously have a circular cross section. In a variant or in addition, still according to the same embodiment, the channel 322g, and consequently the inner wall, of the bracket 322 can advantageously have a substantially rectangular cross section and the channel 323g and consequently the inner wall, of the bracket 323 can advantageously have a substantially oblong cross section. However, the invention will not be limited to these examples of channels and/or brackets alone. The choice of a specific channel and/or a particular bracket with respect to another channel and/or bracket will depend mainly on the orthodontic treatment prescribed.

When the channel 321g, 322g, 323g, and consequently the inner wall of the bracket 321g, 322g, 323g, of a dental orthosis 3 according to the invention, have a substantially square or rectangular cross section, the invention provides for the ridges of the inner wall of the bracket 321g, 322g, 323g respectively to describe axes of revolution of open cylinders, in this case four, opening into said channel 321g, 322g, 323g. In other words, the channel, 321g, 322g, 323g can describe a substantially square or rectangular cross section the angles of which are similar to open circles, in this case four, opening into the channel 321g, 322g, 323g. The presence of such open cylinders proves to be particularly advantageous, so as to avoid, during the manufacture, in particular additive manufacture, or during the use of a dental orthosis 3 according to the invention, deposition of materials in proximity to said ridges or angles.

When a dental orthosis 3 according to the invention comprises a bracket 322 the cross section of the channel 322g, and thus the inner wall of the bracket 322, of which is substantially rectangular, the cross section of said inner wall can be substantially rectilinear or constant. In a variant or in addition, when the length of the bracket is greater than customarily, the invention provides for the cross section of said inner wall to be able to be variable, more particularly hollow at the centre of the bracket, i.e. comprising one or more shoulders or annular grooves, the lateral ends of the inner wall being able to have narrower cross sections, ensuring the constraint and the orientation of the orthodontic archwire within said dental orthosis.

As already mentioned, one of the aims of the invention is to ensure permanent and precise co-operation with zero degrees of freedom between the bracket and the outer surface of the body of the dental orthosis, in particular from the perspective of its orientation, in order to preserve the different data associated with the orders. The main drawback of current dental orthoses resides in the fact that such co-operation is generally carried out by means of welding, which can crack, or even break over time. To overcome such a drawback, said body 33 and said protuberance, 341,342 are made in a single piece, i.e. the manufacture of such an orthosis, which will be described later in the document, is produced in single block or also called monobloc appliance. During the design or characterization of a dental orthosis 3 according to the invention, a bracket 321,322,323 is oriented in a personalized manner, depending on the objectives of the orthodontic treatments, in the first, second and third orders. When said bracket of a dental orthosis 3 according to the invention is arranged to be positioned on the vestibular face of a dental crown, the orientation of a bracket can be in accordance with those of the brackets of the other dental crowns so that the contact points are at the same level. The invention will not however be limited to a predetermined orientation and/or position of a bracket within the dental orthosis 3. The orientation and/or the position of a bracket could depend on and/or respond to treatment phases or strategic choices relative to the orthodontic treatment, in particular according to the severity of the malocclusion.

According to the orthodontic treatment chosen and/or the dental crown on which it is intended to place an orthosis according to the invention, such as for example a molar, it may be necessary in certain cases to use different archwire or orthodontic accessories to transmit different forces according to different orders and thus ensure an optimal displacement of the dental crown.

To this end, the invention provides for a dental orthosis 3 according to the invention to be able in addition, to comprise not only a protuberance, as described above, but a plurality of protuberances similar to the latter by their structures and functions. Thus, according to the embodiment of a dental orthosis according to the invention described in relation to FIGS. 4A to 4D, such a dental orthosis 3 can comprise first and second protuberances 341,342 arranged to constitute first and second brackets 321,322,323 by material removal. Preferentially but non-limitatively, according to a non-limitative embodiment of a dental orthosis according to the invention described in relation to FIGS. 4A to 4D, the first and second brackets 321,322,323, and consequently the first and second protuberances 341,342 can be arranged to be respectively positioned on the lingual and/or vestibular faces of the dental crown.

In a variant or in addition, when different archwires or accessories are necessary for the placement of a particular orthodontic treatment, according to a non-limitative embodiment of a dental orthosis 3 according to the invention described in relation to FIGS. 4A to 4D, the protuberance or protuberances 341 can be arranged to each constitute a plurality of brackets 321,322 that are different by material removal, such a material removal being made, as described above, virtually or in actuality during a process for the manufacture of a dental orthosis according to the invention.

Preferentially but non-limitatively, in order in particular to comply with the standards in terms of dental hygiene and comply with the requirements in terms of market authorization, a dental orthosis according to the invention can be mainly constituted by one or more biocompatible materials. Such biocompatible materials make it possible in particular to reduce, or even prevent, any risk of allergies, hypersensitivity reactions and/or toxicity. By way of non-limitative examples, the biocompatible material or materials can be selected from a stainless steel, a cobalt-based alloy, such as cobalt-chrome or even “stellite”, titanium or a titanium alloy, zirconium dioxide or oxide, also commonly known by the name “zirconia”, or also polyetheretherketone, also known by the abbreviation “PEEK”. However, the invention will not be limited to this single non-exhaustive list of materials. Any other material capable of ensuring an identical or similar function could instead be used. In a variant or in addition, the material or materials composing the dental orthosis could be chosen depending on their resistance to corrosion and/or their mechanical or chemical degradation.

As already mentioned, the invention also relates to methods for the characterization and the manufacture of a dental orthosis according to the invention. FIG. 5 is a simplified flow diagram of a process for the manufacture of a dental orthosis according to the invention.

Such a process for the manufacture 200 of a dental orthosis according to the invention firstly comprises a method for the characterization 100 of a dental orthosis 3, said dental orthosis 3 also being according to the invention, said method 100 arranged to allow the personalized design i.e. anatomical customization, of said dental orthosis 3 from an image or digital representation of a dental crown of interest of a patient.

Said method for the characterization 100 of a dental orthosis 3 is advantageously implemented by an electronic object (not shown in the Figures for the sake of simplicity), said object advantageously being a smart object. By way of preferred but non-limitative application examples, such an electronic object can consist of a smartphone, a tablet computer and/or a personal computer. More specifically, the electronic object comprises a processing unit, consisting of one or more microcontrollers or microprocessors, tasked to implement said method for the characterization of a dental orthosis or any other processing of the data. In a variant, the invention provides for said method for the characterization of a dental orthosis to be able to be implemented by a processing unit of a remote server accessible from a client workstation for example according to SAAS (“software as a service”) technology. Within the meaning of the invention and throughout the document, by “server” is meant a server in the form of a hardware and software device arranged to deliver storage services or calculation services for one or more clients. The latter are generally portable computers or roaming electronic objects, such as a mobile telephone for example, co-operating with said server via a wired or wireless communications network, when the communication means transmit a wireless communication, implementing internet, intranet, WiFi etc. communication protocols. The electronic object also comprises a program memory, said memory advantageously co-operating with a processing unit by means of internal communication buses or by coupling, arranged to comprise, in the form of a computer program product previously loaded within said memory, a method for the characterization of a dental orthosis according to the invention. Said data can advantageously be, totally or partially, saved to one or more data memories, generally electrically erasable and writable. The data memory can advantageously co-operate with the processing unit by means of internal communication buses and/or merely form one and the same entity with the program memory mentioned previously.

Moreover, the electronic object comprises input and/or output means advantageously co-operating with the processing unit by means of internal communication buses. Such input and/or output buses ultimately make it possible to deliver and/or return to a practitioner or more generally to a user, a rendering or a graphical representation of a dental orthosis according to the invention in particular or even various graphical representations during the design phase of said dental orthosis, such as the body, a protuberance and/or one or more brackets comprised within said dental orthosis. Such representations are preferentially but non-limitively returned in three dimensions. Such a graphical representation can, advantageously and prior to its display, be parameterized, so that for example a colour palette, the size and/or the shape of such a representation is automatically or manually selected. However, the invention will not be limited to these parameters alone. Also, by way of non-limitative example, such input and/or output means can advantageously consist of a human/machine interface or graphical interface, a screen, optionally a touch screen, or any other equivalent means suitable for displaying said graphical representation.

In addition, in order to receive data from the outside world, an electronic object implementing a characterization method according to the invention comprises means for communicating with the outside world, ensuring communication, optionally proximity communication, with any nearby object or device, i.e. within radio communication range for example, said communication means also co-operating with the processing unit by means of internal communication buses. Said communication means can thus ensure communication, optionally wired or wireless, for example when the communication means transmit a wireless communication, by implementing WiFi or Bluetooth communication protocols, to any remote device, such as for example a device adapted to or arranged for producing a dental orthosis, such as for example a device for producing volumes by material agglomeration, or also a server having sequences of three-dimensional digital representations of one or more dental crowns of a patient, thus constituting a patient file, provided that the latter is within communication range. Via said communication means, the electronic object, or more precisely its processing unit, can emit and/or receive messages or signals, hereafter denoted messages in the interests of simplicity, encoding for example a script, intended for a device for producing volumes by material agglomeration or even a first three-dimensional digital representation RN13D of a dental crown originating from a remote server.

Moreover, so that the electronic object can operate with complete autonomy, the latter can advantageously comprise its own electrical energy source, in the form of one or more storage cells previously charged and capable of delivering enough electrical energy to allow the electronic object to operate.

According to the embodiment described in relation to FIG. 5, such a method for the characterization 100 of a dental orthosis 3 according to the invention firstly comprises a step 102 for defining or determining the body 33 of the dental orthosis 3 based on a first three-dimensional digital representation RN13D of a dental crown. Such a first three-dimensional digital representation RN13D of a dental crown can be directly downloaded from a server advantageously arranged to store said first three-dimensional digital representation RN13D. In a variant or in addition, a characterization method 100 according to the invention can comprise a prior step 101 of acquisition of the first three-dimensional digital representation RN13D of a dental crown in three dimensions. By way of non-limitative example, said first three-dimensional digital representation RN13D of a dental crown can be produced from an intraoral scanner. To this end, a three-dimensional digital representation of the mouth of a patient can be acquired directly by means of said intraoral scanner placed in the mouth of the patient. This step is mainly carried out by a practitioner within the dental surgery. The three-dimensional digital representation or representations obtained can then be stored in a server as previously mentioned, and/or post-processed. In a variant or in addition, according to another embodiment example, said first three-dimensional digital representation RN13D can be acquired indirectly by three-dimensional digitization with a portable three-dimensional scanner. To this end, a dental impression made from materials such as silicone, plaster, or an alginate impression material is carried out by negative moulding of the dental arch of the patient, making it possible to “mould” the mouth of the patient. The dental impression can then be digitized directly in three-dimensions using said portable scanner in order to produce a three-dimensional digital representation of the mould and finally a first three-dimensional digital representation RN13D of a dental crown. By way of example, such a digital representation, virtual object or digital avatar can consist of a table of geometric co-ordinates of characteristic points or lines making it possible to digitally understand the volume or the outer contours of a dental crown.

As already mentioned, the step 102 of a method for the characterization 100 of a dental orthosis 3 according to the invention then consists of defining or determining the body 33 of the dental orthosis 3 from said first three-dimensional digital representation RN13D of a dental crown. Advantageously, the step 102 of a method 100 for the characterization of a dental orthosis according to the invention consists of producing a second three-dimensional digital representation RN23D of the body 33 of the dental orthosis 3, so that the inner surface, i.e. the surface intended to be in contact with the dental crown, constitutes a complete or total homothetic projection of the outer surface of the dental crown. The outer surface of the body 33 can itself be obtained by homothetic projection of the inner surface, so that the body 33 has a predetermined minimal thickness, such a thickness optionally being able to depend on the material that will constitute said body.

As previously mentioned, a dental orthosis 3 according to the invention can consist of an orthodontic cap or a molar band. The choice of an orthodontic cap or a molar band, one with respect to the other, depends mainly on the dental crown of interest or more generally on the patient, the preferences of the practitioner and/or on the orthodontic treatment implemented. Thus, according to the choice of the practitioner i.e. according to whether the dental orthosis 3 consists of a molar band or an orthodontic cap, only certain geometric data of the first three-dimensional digital representation RN13D are used. In fact, the body of a dental orthosis according to the invention is arranged, more particularly dimensioned, so that covering the dental crown on which the dental orthosis is placed, is limited to the necessary minimum, in order to give greater comfort to the patient. Thus, according to a first embodiment, when the dental orthosis consists of a molar band, the body of the molar band consisting of a ring, step 102 consists of dimensioning said body so that it does not cover the occlusal face and so that the height of the ring of said body is close to the gingival contour. The step 102 can thus comprise a sub-step of determining the gingival contour. In a variant, when the dental orthosis 3 consists of an orthodontic cap, in order to limit the covering of the dental crown, it is possible, or even in certain cases necessary, to limit the covering of the body of the dental orthosis to the suprabulge of the dental crown only. To this end, the step 102 can thus comprise a sub-step of determining the largest contour of the outer wall of the body, in order to minimize the volume of the body surrounding the dental suprabulge. Thus, by using a dental orthosis in the form of an orthodontic cap, the undercut of the dental crown will not be covered, thus reducing the discomfort and the risk of injury of the patient, thus avoiding the uncomfortable use of dental separators generally used during the installation of bands and consequently limiting the number of appointments with the practitioner. Similarly, such a step 102 can consist of minimizing the occlusal thickness of the dental orthosis. To this end, the step 102 can thus comprise a sub-step intended to remove any material detrimental to the occlusion, such removed material not presenting any advantage for the anchoring of the dental orthosis. By way of non-limitative example, such a sub-step can consist of defining respective average, maximum and minimum values of the distances between the inner surface and the outer surface in the area of the occlusal face of the dental crown.

Such processing of a step 102 can be automated from predetermined parameters of a program or sub-program implemented by the electronic object implementing the characterization method 100. Such an action can also be semi-automatic and require human intervention by means of a human/machine interface co-operating with or comprised within said electronic object, such a human/machine interface being able for example to consist of a touch screen, a keyboard a pointing device to facilitate the implementation of said step 102.

Optionally, in a variant or in addition, the electronic object implementing the method 100 comprising output means, such as by way of non-limitative example a human/machine interface, such as a screen or any other equivalent means, to a user of said object and/or device, said output means co-operating with the processing unit of said electronic object, the invention provides for a characterization method 100 according to the invention to also be able to comprise a subsequent step to trigger the return, i.e. the display, of the second three-dimensional digital representation RN23D of the body 33 of the orthosis 3. The display of such a second three-dimensional digital representation RN23D can advantageously be carried out in two or three dimensions and consist mainly of displaying a virtual object or avatar. The graphical representation of such a second three-dimensional digital representation RN23D generally depends on a large number of factors, in particular and by way of non-limitative examples, preferences of the user or of the practitioner, elements that can be parametrized on the output means, indicating for example a choice of orientation or of texture of such a representation of the body of the orthosis, etc. Thus, prior to the step of displaying such a second three-dimensional digital representation RN23D, a method 100 according to the invention can optionally comprise a step of configuring respective parameters of said output means, in particular and optionally of the graphical representation of such a digital representation, in particular but non-limitatively the shape, the texture or also a colour palette used. The second three-dimensional digital representation RN23D can also comprise geometric data characterizing the inner and/or outer surfaces of the body of the dental orthosis. In a variant or in addition, the invention also provides for such geometric data characterizing the inner and/or outer surface of the body of the dental orthosis to be able to be deduced from volume characteristics of the avatar or virtual object.

At the end of implementation of the step 102, the method 100 has determined the characteristic data making it possible to characterize the body 33 of a dental orthosis, while seeking to retain only the strictly necessary in terms of parts of the faces of the dental crown covered by the body, in order in particular not to obstruct the occlusion while offering an optimal grip of the orthosis on the dental crown, and at the end of this step 102, having available a base sufficient to constitute one or more brackets.

Determining such a bracket is carried out by implementing a step 103. The latter consists of selecting automatically, when possible, or semi-automatically, or assisted by an interaction of a human user, the type and/or the shape of the bracket, more particularly the channel of said bracket. The latter can in fact, using a suitable human/machine input interface, such as, as mentioned previously, a human/machine interface co-operating with or comprised within said electronic object, select and/or position, not a bracket like the known solutions, but the channel of said bracket, the body of the bracket being determined later in step 104. A channel, determined by a transverse cross section, a length, an orientation relative to the body of the orthosis and/or a longitudinal axis, can be associated with proximity to the outer surface of the avatar of the body of the orthosis. Such a step 103 can optionally be iterated if the dental orthosis is arranged to comprise a plurality of brackets. The step 103 thus consists of producing geometric data relative to one or more respective channels of brackets in addition to the geometric data characterizing the avatar of the body of the dental orthosis, such a body being homothetically arranged on the dental crown, said geometric data having been previously determined in step 102.

To constitute a complete avatar of an orthosis 3 according to the invention, such an orthosis being arranged in a single piece and comprising one or more brackets, a characterization method 100 according to the invention comprises a step 104 to arrange a lingual or vestibular protuberance in the form of an protrusion of the outer surface of the avatar of the body produced in 102, so that, by deformation or projection of said surface, said deformation generally inducing a convex-shaped protrusion said outer surface preferentially covers the channel or channels, selected in step 103 over the main part or all of the length of each of these, having a thickness, i.e. a distance separating the inner wall of the channel from the outer wall of the body, greater than or equal to a predetermined value. Advantageously, to confer optimal comfort to the patient, such a step 104 will seek to minimize any sudden break or discontinuity, during the formation of a protuberance realizing a unitary bracket body with that of the body determined in step 102, to determine characteristic and geometric data of said protuberance, so that any ridge or asperity is absent or minimized. At the end of the implementation of step 104, a characterization method 100 according to the invention has determined the avatar of a single-piece orthosis optionally comprising one or more brackets. The step 104 thus makes it possible to have available a third three-dimensional digital representation of the final dental orthosis 3. It should be noted that the formation of a protuberance encapsulating a channel can also be carried out by means of a “deformation or projection” of the avatar of the body produced in step 102, like the deformation or projection described in relation to step 104, prior to the implementation of step 103 intending to position a channel. This embodiment variant can be useful and usable, in particular in the case where the shape of said protuberance can be globally predetermined and standard, independently of the bracket to be integrated. According to such an arrangement, a step of correcting the geometry of the protuberance could be implemented if the shape or the volume thereof proved to be insufficient or unsuitable for the channel or channels selected and positioned in step 103.

Optionally, in a variant or in addition, an electronic object implementing the method 100 comprising output means, such as by way of example a human/machine interface, such as a screen or any other equivalent means, to a user of said object and/or device, said output means co-operating with the processing unit of said electronic object, the invention provides for a characterization method 100 according to the invention to also be able to comprise a subsequent step to trigger the return, i.e. the display, of the third three-dimensional digital representation RN33D of the body of the orthosis 3. Like the display of such a second three-dimensional digital representation RN23D, the display of such a third three-dimensional digital representation RN33D can advantageously be carried out in two or three dimensions and mainly consists of displaying a virtual object the parameters of which can be defined or predetermined.

At the end of the step 104, a characterization method 100 according to the invention can comprise a step 105 for indicating the third three-dimensional digital representation RN33D or the avatar of the orthosis 3 in the form of a script or a set of instructions, with the aim of controlling a device for producing the dental orthosis by material addition, commonly called device for producing volumes by material agglomeration or three-dimensional printer (3D).

Thus, a method 100 for determining the geometric characteristics of a dental orthosis from a single piece comprising a bracket, or for producing a script for implementing additive manufacturing technologies, has been described completely. Regardless of the configuration of a method 100 for characterization of a dental orthosis 3 according to the invention, said method 100 being according to the invention, a preferred adaptation of a smart electronic object, as described above, consists of saving or loading to a program memory a computer program product P comprising a plurality of program instructions which, when they are executed or interpreted by the processing unit of said electronic object, cause the implementation of said method 100 for characterization of a dental orthosis according to the invention.

The invention also relates to a process for the manufacture 200 of a dental orthosis 3, said orthosis 3 being according to the invention. Such a manufacturing process 200 consists of a process for shaping the dental orthosis, such shaping being produced based on the avatar, also called third digital representation, of a single-piece dental orthosis 3 designed by means of a method for the characterization 100 of a dental orthosis according to the invention. To this end, said manufacturing process 200 can comprise all or some of the steps 101,102,103,104,105 of said method 100 for the characterization of a dental orthosis.

Once the avatar of the single-piece dental orthosis has been obtained, there follows a step of shaping said dental orthosis, consisting of physically creating said orthosis. Preferentially but non-limitatively, in order to offer many possibilities for customization and to propose dental orthoses adapted to each patient, such a shaping step consists of a step of additive manufacturing of said dental orthosis, consisting of a three-dimensional printing step. Such an additive manufacturing step 202, advantageously implemented by the processing unit of the device for producing the dental orthosis by material addition, commonly called device for producing volumes by material agglomeration or three-dimensional (3D) printer, can use different types of additive manufacturing technologies, such as by way of non-limitative example, SLM (“selective laser melting”) or LBM (“laser beam melting”) technologies. Preferentially, said additive manufacturing step 202 can be based on an MBJ (“metal binder jetting”) technology. However, the invention will not be limited to these technology examples alone and could use any additive manufacturing technology considered suitable for a dental orthosis according to said invention.

In a variant, the shaping step can consist of a step of subtractive manufacturing 201 of said dental orthosis to carry out material removal and constitute the bracket, consisting of a step of drilling, machining or milling after the body and one or more protuberances have been produced by casting of material within a mould. To this end, based on the avatar, also called third digital representation, a mould can be constituted beforehand. A step of subtractive manufacturing 201 of said dental orthosis can then comprise an operation of casting or injection moulding of the dental orthosis 3 in a single piece followed by a machining operation, for example by means of a digitally controlled milling cutter, for removing material in a protuberance 341,342 and for producing an optional channel of a bracket.

Regardless of the embodiment of the shaping step, the dental orthosis obtained always consists of a single piece the body of which was produced in a single block and for which one or more brackets are produced by material removal either by digital design in the context of the implementation of a additive manufacturing step, the removal being carried out virtually before the shaping of the dental orthosis, either physically in the context of the implementation of a subtraction manufacturing step, the removal being carried out by milling for example.

Such a manufacturing process 200 can be implemented by the same electronic object implementing the characterization method 100 or by a separate device using the third three-dimensional digital representation of the orthosis obtained in step 104 or the script obtained in step 105. In this case, a device implementing the shaping steps can be adapted by loading a computer program in a program memory of said object the instructions of which cause the implementation of the manufacturing method 200, during their interpretation by the processing unit of said device.

Finally, one of the aims of the invention consists of using one or more dental orthoses according to the invention previously described and arranged in the context of a specific and personalized orthodontic treatment. To this end, the invention also relates to an orthodontic appliance 1. As described previously, such an orthodontic appliance comprises at least two dental orthoses 3 and an orthodontic archwire 2 co-operating with said two dental orthoses 3. Advantageously but non-limitatively, at least one of the two dental orthoses 2 is according to the invention.

1. Dental A dental orthosis comprising:
a body having an inner surface and an outer surface, said body being arranged to homothetically cover a part of a dental crown, and
a bracket having a channel and co-operating with zero degrees of freedom with the outer surface of said body, wherein:
the inner surface of said body is arranged to homothetically cover at least a part of three faces of said dental crown, one of which comprising the vestibular face and the two others being selected from the lingual face, the occlusal face, the distal face and the mesial face, said bracket being arranged to be positioned on the vestibular face of the dental crown,
the outer surface of said body comprises a regular protuberance, said protuberance being arranged to constitute said bracket by material removal,
said body and said protuberance are made in a single piece.

2. The dental orthosis according to the preceding claim 1, wherein the protuberance is convex.

3. The dental orthosis according to claim 1, wherein the inner surface of said body is arranged to homothetically cover a part of the occlusal face and a part of the lingual face and a part of the vestibular face of said dental crown.

4. The dental orthosis according to claim 1, wherein the channel of the bracket is tubular with a circular or rectangular cross section.

5. The dental orthosis according to claim 1, wherein the outer surface of the body is smooth, so that it does not have any asperity.

6. The dental orthosis according to claim 1, comprising an orthodontic cap or a molar band.

7. The dental orthosis according to claim 1, comprising a second protuberance arranged to constitute a second bracket by material removal, said second bracket being arranged to be respectively positioned on the lingual face of the dental crown.

8. The dental orthosis according to claim 1, wherein the protuberance is arranged to constitute a plurality of different brackets by material removal.

9. The dental orthosis according to claim 1, wherein said orthosis is mainly constituted by biocompatible material.

10. A method for the characterization of a dental orthosis, said orthosis being according to claim 1, said method comprising:
a step for defining the body of the dental orthosis based on a first three-dimensional digital representation of a dental crown and producing a second three-dimensional digital representation of the body of the orthosis;
a step for selecting and associating with the second three-dimensional digital representation of the body of the orthosis the channel of the bracket with respect to the outer surface of the body;
a step for creating the protuberance by non-linear projection of the inner surface of the body, so that said protuberance constitutes the bracket.

11. The characterization method according to claim 10, comprising a prior step of acquisition of the first three-dimensional digital representation of a dental crown.

12. The characterization method according to claim 10, comprising a step of producing a script that can be interpreted or executed by the processing unit of a device for developing volumes by addition of material, the interpretation or execution of which causes the production of the dental orthosis.

13. A non-transitory computer-readable medium encoded with a program comprising one or more instructions that can be interpreted or executed by a processing unit of an electronic object, the electronic object also comprising a memory or co-operating with a memory, said program being able to be loaded in said storage means, wherein the interpretation or execution of said instructions by said processing unit causes the implementation of a characterization method according to claim 12.

14. A process for the manufacture of a dental orthosis, comprising:
the steps of the characterization method of a dental orthosis according to claim 10; and
a step of subtractive manufacturing of said dental orthosis to carry out the material removal and constitute the bracket, comprising a step of drilling, machining or moulding.

15. A process for the manufacture of a dental orthosis, comprising:
the steps of the characterization method of a dental orthosis according to claim 10; and
a step of additive manufacturing of said dental orthosis, comprising a three-dimensional printing step.

16. An orthodontic appliance comprising two dental orthoses and an orthodontic archwire co-operating with said two dental orthoses, wherein at least one of the two orthoses is according to claim 1.
